(19) United States
(12) Patent Application Publication
(10) Pub. No.: US 2005/0219659 A1
(43) Pub. Date: Oct. 6, 2005

(54) Reproduction of alternative forms of light from an object using digital imaging system

(76) Inventor: Shuxue Quan, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/816,055

(22) Filed: Mar. 31, 2004

(51) Int. Cl. H04N 1/48; H04N 1/04; H04N 9/09

(52) U.S. Cl. 358/512; 348/262; 358/514

(57) ABSTRACT

According to one embodiment of the invention, a digital imaging device is described having filters to capture colorimetric information of visual light at a first and a second set of wavelengths. The captured colorimetric information is processed to reproduce a surface reflectance of an object in a scene.

### FIELD OF THE INVENTION

This invention relates generally to digital imaging, and more particularly to reproducing alternative forms of light from an object using digital imaging.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2003, Sony Electronics, Inc., All Rights Reserved.

### BACKGROUND

Traditional digital color imaging systems such as a digital camera or a digital camcorder use either one or three image sensors (e.g., a charge coupled device (CCD) or a complementary metal-oxide semiconductor (CMOS)) well known to those of ordinary skill in the art. For example, a typical consumer digital camera includes one. CCD, while a typical digital camcorder includes three CCDs. A digital camera having one CCD may have a single trichromatic filter. The trichromatic filter consists of red, green, and blue filters to reproduce a color spectrum in a scene using a process well known to those of ordinary skill in the art. A digital camera having one CCD does not have as high a color resolution as a digital camcorder having three CCDs. A digital camcorder having three CCDs typically includes a filter over each CCD. The first filter over the first CCD to filter only the red color spectrum, the second filter over the second CCD to filter only the green color spectrum, and the third filter over the third CCD to filter only the blue color spectrum.

While consumers enjoy the advantages of the trichromatic reproduction capability of these cameras, some serious drawbacks have always accompanied them, such as illuminant estimation and color correction due to infinite choices of illuminants. Furthermore, conventional digital imaging systems lack the capability to capture alternative forms of light under multiple illumination conditions, such as the surface reflectance of objects. Reflectance is the ratio of incident luminous flux upon a surface which is reradiated in the visual spectrum. There are a number of image devices that may capture and reproduce the surface reflectance of an object but these imaging devices are not feasibly included in a commercial consumer digital camera or camcorder because of cost and speed to capture an image. For example, a conventional spectro-radiometer may reproduce a surface reflectance of an object but capturing a complete spectral image of a scene typically takes much longer than just several minutes. This is not feasible for most digital commercial imaging systems because objects in a scene tend to move. Any movement of objects will cause pixel mis-registration and blur the final image.

### SUMMARY OF AN EMBODIMENT OF THE INVENTION

According to one embodiment of the invention, a digital imaging device is described having filters to capture colorimetric information of visual light at a first and a second set of wavelengths. The captured colorimetric information is processed to reproduce a surface reflectance of an object in a scene.

### BRIEF DESCRIPTION OF THE DRAWINGS

FIG. 1 illustrates a digital imaging device according to an embodiment of the invention.

FIG. 2 illustrates a trichromatic filter according to one embodiment of the invention.

FIG. 3 illustrates one embodiment of a wavelength chart for visible light.

FIG. 4 illustrates one embodiment of a process flow for the reproduction of a surface reflectance of objects.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

The reproduction of the surface reflectance of an object using a digital imaging device is described. According to one embodiment, the digital imaging device includes, but is not limited to, two imaging sensors and two trichromatic filters to provide six imaging channels. The two trichromatic filters are designed to capture colorimetric information of various wavelengths to reproduce alternative forms of light such as the surface reflectance of objects in a scene. Although the following will describe an embodiment of a digital imaging device that includes trichromatic filters, one of ordinary skill in the art will recognize that the filters may be used to provide a varying number of imaging channels to the imaging sensors, as will be further described below.

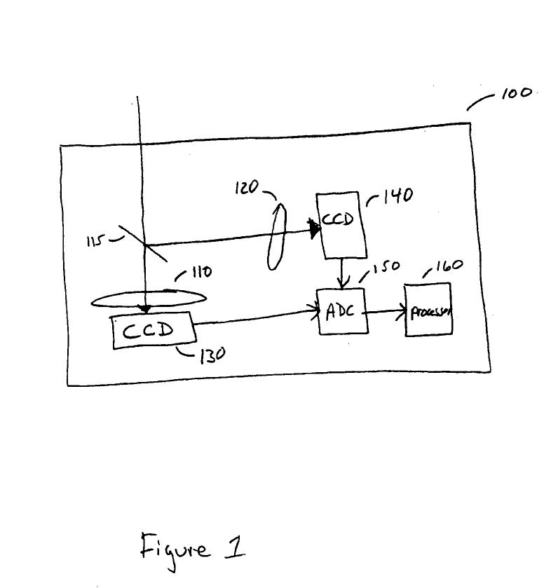

FIG. 1 illustrates a digital imaging device 100 according to an embodiment of the invention. The digital imaging device 100 includes a trichromatic filter 110, a trichromatic filter 120, a beam splitter 115, a charge coupled device (CCD) 130, a CCD 140, an analog-to-digital converter (ADC) 150, and a processor 160. The digital imaging device 100 also includes additional components and circuitry that are well known to those of ordinary skill in the art but are not shown so as to not obscure the detailed description. The following provides a brief overview of the device 100 as shown in FIG. 1.

The trichromatic filter 110 and trichromatic filter 120 filter visible light to the CCD 130 and CCD 140, respectively, to capture colorimetric information used to reproduce a digital representation of a scene, as will be further described below. As shown, the light is separated into two components with the beam splitter 115.

The CCD 130 and the CCD 140 are imaging sensors that include a collection of light-sensitive diodes called photosites, which convert light (photons) into electrons (electrical charges). The primary function of each of the photosites is to absorb light, which results in an electrical charge that is directly proportional to the intensity of the light shining on it. In this way, the photosite tracks the total intensity of the light as it passes through the trichromatic filter 110 and trichromatic filter 120 that strikes its surface.

The ADC 150 converts the electrical charges that build up in the CCD 130 and CCD 140 into digital signals.

The processor 160 processes the digital signals into the digital image representation of the scene. The processor 160 may be, for example, a well-known digital signal processor (DSP). In one embodiment, the processor 160 processes each digital signal for each photosite to determine a color of a pixel in the digital image. The processor 160 may also correct and enhance the digital image for white balance, contrast, color, and other well-known visual characteristics. The processor 160 may also direct the digital image onto a local display (e.g. LCD display) coupled to the digital imaging device 100 or direct the digital image to a remote display via a wired or wireless network connection (not shown). Furthermore, the processor 160 may also compress the digital image as is well known to those of ordinary skill in the art.

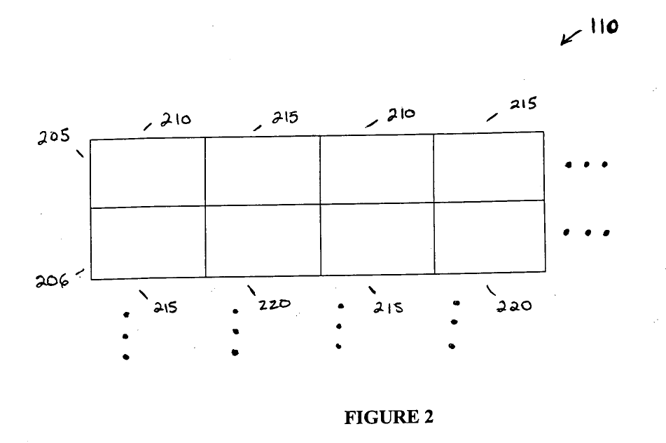

Having provided a brief overview of the digital imaging device 100, embodiments of the trichromatic filter 110 and the trichromatic filter 120 will now be described. FIG. 2 illustrates a trichromatic filter 110 according to one embodiment of the invention. The trichromatic filter 110 includes a pattern of alternative row 205 of red (210) and green (215) filters with row 206 of green (215) and blue (220) filters. In this way, the trichromatic filter 110 provides a set of three imaging channels (e.g., RGB) of the light to the CCD 130. One example of the trichromatic filter 110 is a Bayer filter, well known to those of ordinary skill in the art; however, it is apparent that the invention is not limited to use of a Bayer filter.

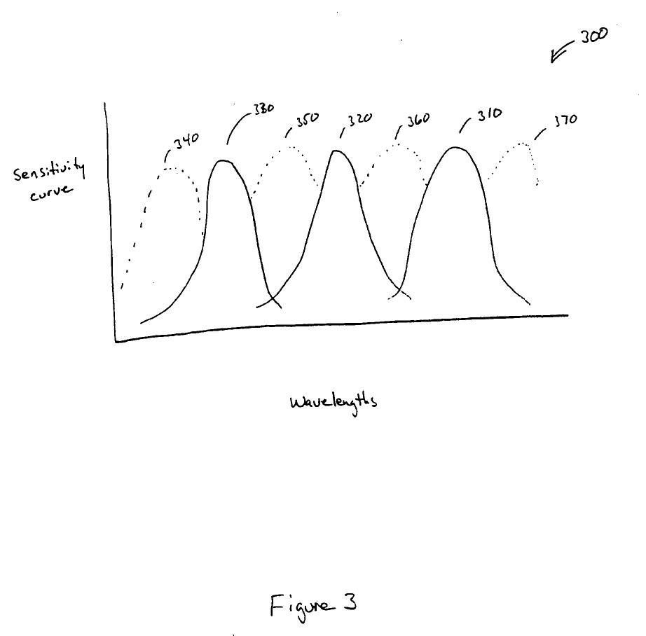

It is well understood that visible light is that portion of the color spectrum between the wavelengths of about 400 nanometers (nm) and 800 nm. The different wavelengths are interpreted by the human brain as colors, ranging from red at the longest wavelengths to violet at the shortest wavelengths. FIG. 3 illustrates one embodiment of a wavelength chart 300 for visible light. Wavelength 310 illustrates the range and sensitivity curve of the color red. Wavelength 320 illustrates the range and sensitivity curve of the color green. Wavelength 330 illustrates the range and sensitivity curve of the color blue. The light sensitivity curve is the multiplication of filter transmittance, lens transmittance, infrared cutoff transmittance, and electronic sensor responsitivity at each wavelength, which is well known to those of ordinary skill in the art.

In one embodiment, the trichromatic filter 110 is designed so that the red filters 210 are most responsive to those wavelengths of between approxiately 570 to 620 nm as illustrated in FIG. 3, the green filters 215 are most responsive to those wavelengths of between approxiately 520 to 560 nm as illustrated in FIG. 3, and the blue filters 230 are most responsive to those wavelenghts between approximately 420 to 470 nm as illustrated in FIG. 3.

In one embodiment, the trichromatic filter 120 is designed to capture the visible light of a set of wavelengths other than those captured by the trichromatic filter 110. For example, wavelength 340 of FIG. 3 illustrates the approximate wavelength range and the sensitivity curve for an offset color W this is less than the blue filter wavelength 330; wavelength 350 of FIG. 3 illustrates the approximate wavelength range and the sensitivity curve for an offset color X that is between the green and blue filter wavelength; wavelength 360 of FIG. 3 illustrates the approximate wavelength range and the sensitivity curve for an offset color Y that is between the green and red filter wavelength; and wavelength 370 of FIG. 3 illustrates the wavelength range and the sensitivity curve for an offset color Z that is greater than the red filter wavelength.

Prior art digital cameras and camcorders only provide three imaging channels (e.g., RGB) regardless of the number of CCDs used. The trichromatic filter 120 in the digital imaging device 100 provides three additional imaging channels to the CCD 140, each of which has a wavelength separate from those captured by trichromatic filter 110 to the CCD 130. The additional three channels work with the first three channels to calculate spectral reproduction of alternative forms of light as will be described. In one embodiment, the digital imaging device 100 may be used to extract information of spectral radiance or reflectance of objects. Once the reflectance spectra information is acquired, conversion of colorimetric information under any viewing illuminant can be achieved.

Generally, the reflectance spectra of natural objects can be represented with a limited number of basis functions in terms of principal component analysis (PCA) or independent component analysis (ICA). Typical spectral imaging using a wide band technique applies three to nine basis functions to reproduce the reflectance spectra of natural objects. A wide-band approach is based on the spectral analysis of the objects to be captured. It has been shown that three basis functions are usually not enough to represent the object's reflectance spectra, but six basis functions can accurately represent the object's reflectance spectra in most cases.

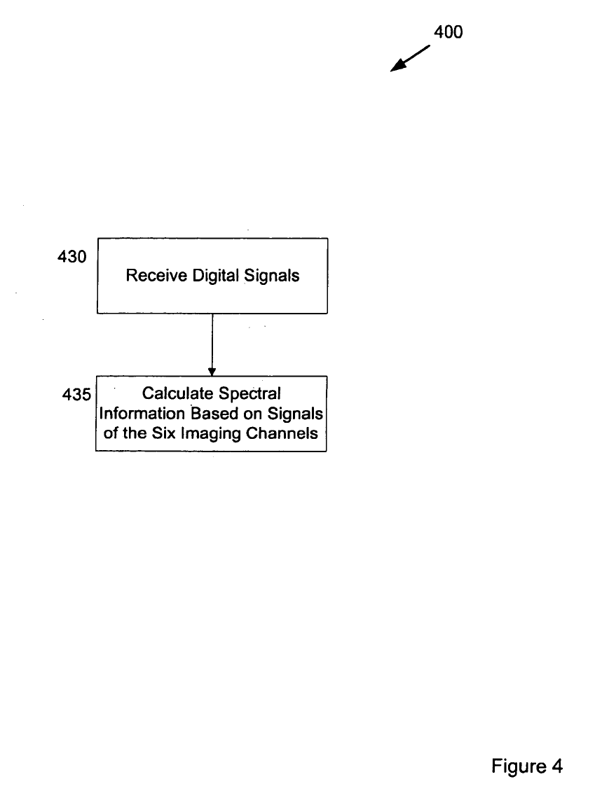

For example, FIG. 4 illustrates one embodiment of a process flow 400 for the reproduction of a surface reflectance of objects by a processor, such as processor 160. At block 430, the processor 160 receives the digital signals from the ADC 150.

At block 435, the processor 160 calculates the spectral information of the objects based on the six imaging channels. In this fashion, a digital imaging device using two CCDs and two filters provides both high speed and spectral reproduction capabilities. The spectral recovery methods could be principal component analysis (PCA), independent component analysis (ICA), or Wiener estimation. For spectral reproduction, the straightforward metric is the means-squared spectral difference of the measured and recovered surface reflectance spectra of objects. In one embodiment, metrics are first defined to determine the optimal design of spectral sensitivities for spectral reproduction. The candidate metrics to define spectral difference are:

Candidate 1: Mean Square Error of Reflectance Spectra
MSE=E{∥R−\hat{R}∥²} (1)
where R is the measured reference spectral reflectance, and \hat{R} is the recovered spectral reflectance; and
Candidate 2: Weighted Mean Square Error of Reflectance Spectra
MSE_{w}=E{∥w_{λ}(R−\hat{R})∥²} (2)
where w_{λ} is a weighting function appearing as a diagonal matrix with diagonal elements from the samplings of weighting functions related to the human visual system, such as the q-factor curve emphasizing the prime wavelengths of the human visual system.

As stated above, there are several approaches to recovering the surface reflectance spectra of objects and the normalized metrics. For example, with the principal component analysis, it is a known fact that most naturally occurring spectral reflectance can be represented from a limited number of principal eigenvectors, obtained from the principal component analysis of a representative reflectance sample. The output of the digital imaging device 100 can be written as:
t_{c}=S^{T}L_{c}R=S^{T}L_{c}Bα (3)
where S denotes the camera spectral sensitivities, L_{c} denotes the diagonal form of the taking illuminant, B denotes the principal component vectors obtained via PCA or ICA from a training set of spectral reflectance samples, and α denotes the weights for the principal components (R≅Bα). α can be obtained using pseudo-inverse operation:
α=(S^{T}L_{c}B)⁻¹t_{c} (4)
Therefore the recovered spectral reflectance is represented as
\hat{R}=Bα=B(S^{T}L_{c}B)⁻¹t_{c} (5)
The minimized mean square error of spectral difference is
MSE=E{∥R−(S^{T}L_{c}B)⁻¹t_{c}∥²} (6)

When using Wiener estimation to recover the surface reflectance spectra of objects and normalize metrics the output signal of the digital imaging device 100 is expressed as
t_{c}=S^{T}L_{c}R=G^{T}R+η (7)
where η denotes the imaging noise. The estimation of R is given by
\hat{R}=F·t_{c} (8)
where F is a unknown linear transformation matrix. Minimizing MSE in Equation (1), the explicit form of F is given as
F=K_{R}G(G^{T}K_{R}G+K_{η})⁻¹ (9)
where K_{R} and K_{η} are the correlation matrices of the ensemble of surface reflectance spectra and noise respectively.

Noise correlation matrix K_{η} can be estimated from detail measurement of noise for CCD cameras actually used, and

$$\begin{matrix}{K}_{R} = E [ {RR}^{T} ] = \frac{1}{{n}_{sample}} {RR}^{T} & ( 10 ) \\ {K}_{η} = E [ {ηη}^{T} ] & ( 11 )\end{matrix}$$

where nₛₐₘₚₗₑ is the number of samples in the ensemble of spectral reflectance. Therefore the minimal mean squared error in Equation (1) can be represented as

$$\begin{matrix}\begin{matrix}MSE = E \{ {‖ ( R - \hat{R} ) ‖}^{2} \} \\ = E \{ {‖ R - {K}_{R} {G ( {G}^{T} {K}_{R} G + {K}_{η} )}^{- 1} {t}_{C} ‖}^{2} \}\end{matrix} & ( 12 ) \\ = α ( R ) - τ ( R , G , η ) where & ( 13 ) \\ α ( R ) = trace [ {K}_{R} ] & ( 14 ) \\ τ ( R , G , η ) = trace [ {K}_{R} {G ( {G}^{T} {K}_{R} G + {K}_{η} )}^{- 1} {G}^{T} {K}_{R} ] & ( 15 )\end{matrix}$$

The meaning of α(·) and τ(·) can be interpreted as the total spectral information of objects and the recovered spectral information of objects. The normalized metric corresponding to the minimal MSE

$${q}_{SR} = \frac{τ ( R , G , η )}{α ( R )} \qquad ( 16 )$$

will be referred as spectral quality factor, or the quality factor for spectral reproduction.

Besides the mean squared error of spectral reflectance as a primary metric, the mean color difference under a specific illuminant can be treated as a secondary metric to the optimal design of filters for spectral reproduction. A small collection of optimal candidates generated with a primary metric can be refined with the secondary metrics.

In one embodiment, Wiener estimation with a weighting function may be used by minimizing MSE_{w} in Equation (2), the reflectance spectra is estimated as
\hat{R}=K_{R}G(G^{T}K_{R}G+K_{η})⁻¹ (17)
and the minimal mean squared error of spectra is

$$\begin{matrix}\begin{matrix}{MSE}_{w} = E \{ {‖ {w}_{λ} ( R - \hat{R} ) ‖}^{2} \} \\ = E \{ ‖ {{w}_{λ} ( R - {K}_{R} {G ( {G}^{T} {K}_{R} G + {K}_{η} )}^{- 1} ‖}^{2} \}\end{matrix} & ( 18 ) \\ = α ( R , {w}_{λ} ) - τ ( R , G , η , {w}_{λ} ) where & ( 19 ) \\ α ( R , {w}_{λ} ) = trace [ {w}_{λ}^{2} {K}_{R} ] & ( 20 ) \\ τ ( R , G , η , {w}_{λ} ) = trace [ {w}_{λ} {K}_{R} {G ( {G}^{T} {K}_{R} G + {K}_{η} )}^{- 1} {G}^{T} {K}_{R} ] & ( 21 )\end{matrix}$$

Thus a normalized metric can be defined as

$${q}_{SR} = \frac{τ ( R , G , η , {w}_{λ} )}{α ( R , {w}_{λ} )} \qquad ( 22 )$$

It will be appreciated that more or fewer processes may be incorporated into the method illustrated in FIG. 4 without departing from the scope of the invention and that no particular order is implied by the arrangement of blocks shown and described herein. It further will be appreciated that the methods described in conjunction with FIG. 4 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions which may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and carrier wave signals. Furthermore, it is common in the art to speak of software, in one form or another (e.g., program, procedure, process, application, module, logic, etc), as taking an action or causing a result. Such expressions are merely a shorthand way of saying that execution of the software by a computer causes the processor of the computer to perform an action or produce a result.

Thus, a new digital color imaging system having two imaging sensors and two filters providing multiple imaging channels has been described. The image registration from two CCDs is faster and more efficient than from a three CCD system. The new configuration of the digital imaging device 100 will not substantially increase the size of a single chip digital camera because only the filter patterns are different for the two imaging sensors. However, it is also apparent that the invention is not limited to digital cameras and camcorders but may be used in any imaging device well known to those of ordinary skill in the art.

It should be noted that trichromatic filter 110 and trichromatic filter 120 are not limited to only trichromatic filters. Rather, in an alterative embodiment, the trichromatic filter 110 may include two wavelengths of the color green to provide four imaging channels. Further, the trichromatic filter 120 may provide any number of color imaging channels other than three (e.g., one, two, or four), each having a wavelength different from the trichromatic filter 110. In this way, the digital imaging system 100 may produce multiple color imaging channels for each wavelength.

While the invention has been described in terms of several embodiments, those skilled in the art will recognize that the invention is not limited to the embodiments described. The method and apparatus of the invention can be practiced with modification and alteration within the scope of the appended claims. The description is thus to be regarded as illustrative instead of limiting on the invention.

1. A digital imaging system comprising:
a first imaging sensor;
a second imaging sensor, the second imaging sensor coupled to the first imaging sensor;
a first filter coupled to the first imaging sensor, wherein the first filter filters light at a first set of wavelengths; and
a second filter coupled to the second imaging sensor, wherein the second filter filters light at a second set of wavelengths, the first set of wavelengths being different from the second set of wavelengths.

2. The digital imaging system of claim 1 further comprising:
a processor to calculate a surface reflectance of an object based on the first set of wavelengths and the second set of wavelengths.

3. The digital imaging system of claim 1, wherein the first imaging sensor is a charge coupled device (CCD) or a complementary metal-oxide semiconductor.

4. The digital imaging system of claim 1, wherein the second imaging sensor is a charge coupled device (CCD) or a complementary metal-oxide semiconductor.

5. The digital imaging system of claim 1, wherein the first filter is a trichromatic filter.

6. The digital imaging system of claim 1, wherein the second first filter is a trichromatic filter.

7. The digital imaging system of claim 1, wherein the first filter provides for three imaging channels.

8. The digital imaging system of claim 1, wherein the first filter provides for four imaging channels.

9. The digital imaging system of claim 1, wherein the second filter provides for three imaging channels.

10. The digital imaging system of claim 1, wherein the second filter provides for four imaging channels.

11. The digital imaging system of claim 1, wherein the second filter provides for two imaging channels.

12. The digital imaging system of claim 1, wherein the second filter provides for one imaging channel.

13. A digital imaging apparatus comprising:
a first means for capturing colorimetric information;
a second means for capturing colorimetric information, the first means for capturing colorimetric information coupled to the second means for capturing colorimetric information;
a first means for filtering coupled with the first imaging sensor means, wherein the first means for filtering to filter light at a first set of wavelengths; and
a second means for filtering coupled with the second imaging sensor means, wherein the second means for filtering to filter light at a second set of wavelengths, the first set of wavelengths being different from the second set of wavelengths.

14. The digital imaging apparatus of claim 13 further comprising:
a means for processing to calculate a surface reflectance of an object based on the first set of wavelengths and the second set of wavelengths, the means for processing coupled with the first means for capturing colorimetric information and the second means for capturing colorimetric information.

15. A machine-readable medium having instructions to cause a machine to perform a method, the method comprising:
receiving a first set of wavelengths of light;
receiving a second set of wavelengths of light; and
processing the first set of wavelengths and the second set of wavelengths to calculate a surface reflectance of an object.

16. The machine-readable medium of claim 15, wherein the first set of wavelengths provides three imaging channels.

17. The machine-readable medium of claim 15, wherein the first set of wavelengths provides four imaging channels.

18. The machine-readable medium of claim 15, wherein the second set of wavelengths provides three imaging channels.

19. The machine-readable medium of claim 15, wherein the second set of wavelengths provides four imaging channels.

20. The machine-readable medium of claim 15, wherein the second set of wavelengths provides one imaging channel.

21. The machine-readable medium of claim 15, wherein the second set of wavelengths provides two imaging channels.

22. The machine-readable medium of claim 15, wherein the calculation of the surface reflectance includes performing principal component analysis.

23. The machine-readable medium of claim 15, wherein the calculation of the surface reflectance includes performing independent component analysis.

24. The machine-readable medium of claim 15, wherein the calculation of the surface reflectance includes performing Wiener estimation.

25. A method comprising:
receiving a first set of wavelengths of light;
receiving a second set of wavelengths of light; and
processing the first set of wavelengths and the second set of wavelengths to calculate a surface reflectance of an object.

26. The method of claim 25, wherein the first set of wavelengths provides three imaging channels.

27. The method of claim 25, wherein the first set of wavelengths provides four imaging channels.

28. The method of claim 25, wherein the second set of wavelengths provides three imaging channels.

29. The method of claim 25, wherein the second set of wavelengths provides four imaging channels.

30. The method of claim 25, wherein the second set of wavelengths provides one imaging channel.

31. The method of claim 25, wherein the second set of wavelengths provides two imaging channels.

32. The method of claim 25, wherein the calculation of the surface reflectance includes performing principal component analysis.

33. The method of claim 25, wherein the calculation of the surface reflectance includes performing independent component analysis.

34. The method of claim 25, wherein the calculation of the surface reflectance includes performing Wiener estimation.
